(19) United States
(12) Patent Application Publication
(10) Pub. No.: US 2012/0306232 A1
(43) Pub. Date: Dec. 6, 2012

(54) VEHICLE COVER AND SHELTER

(76) Inventor: Dantzler McPhail SHUMAKER, Columbia, SC (US)

(21) Appl. No.: 13/151,417

(22) Filed: Jun. 2, 2011

(51) Int. Cl. B60J 11/04; E04H 15/02

(52) U.S. Cl. 296/136.07; 135/96

(57) ABSTRACT

A vehicle cover and shelter is adapted to fit over the top of a vehicle, wherein a rear portion of the cover extends beyond the rear of the vehicle and is supported by a collapsible frame assembly to provide a sheltered area thereunder. In one embodiment, the cover fits over the windshield, roof, rear windshield and open trunk of the vehicle, and may be attached to the vehicle using various attachment means. The rear portion of the cover extends beyond the rear of the vehicle to provide a sheltered area adjacent to the rear of the vehicle, without interfering with the use of the car doors and side windows. The collapsible frame assembly may include a pair of legs and an arch assembly to support the rear shelter portion of the cover, and may consist of a series of flexible pole members that fit together, similarly to tent poles.

### BACKGROUND OF THE INVENTION

The present invention relates generally to covers for vehicles. More specifically, the present invention includes a cover that is adapted to fit over at least a portion of a vehicle, wherein the cover extends beyond a rear portion of the vehicle to provide a standing shelter from rain, snow, sunshine or other elements. The automotive cover and shelter is used in combination to protect at least a portion of the vehicle, and also as a “tailgating-style” shelter, so that people may assemble under the shelter to avoid direct sunshine or foul weather.

Heretofore, many automotive covers have been developed and made commercially available. Typically, these covers are used simply to protect vehicles from foul weather when the vehicle is not in use. Additionally, such covers are used to cover the windows of the vehicle in order to keep direct sunlight from heating up the interior of the vehicle to uncomfortable levels, when the vehicle is parked in an area that is exposed to direct sunlight. Further, there are many types of tailgating-style shelters that are commercially available. Generally, these shelters are free-standing, collapsible structures that include a frame and a textile roof or cover. These structures are commonly used in association with outdoor activities, such as sporting events, where a user parks the car in the parking lot of a stadium or arena, and uses the tailgating shelter for pre-game and post-game festivities to protect fans from the elements. Unfortunately, these tailgating style shelters can be difficult to assemble and disassemble, and they are heavy, bulky and cumbersome in their disassembled state.

It would be desirable, therefore, to provide a vehicle cover that could be used simultaneously to protect at least a portion of a vehicle, as well as providing shelter for an area directly behind or adjacent the vehicle for people and/or goods. Additionally, it would be desirable to provide such a cover that could be attached to a vehicle and partially supported thereby, and where a small, compact, frame assembly could be easily erected and used to support an outer portion of the cover.

### BRIEF SUMMARY OF THE INVENTION

In accordance with one aspect of the invention, a vehicle cover is adapted to fit over the roof of a vehicle, wherein a rear portion of the cover extends beyond the rear of the vehicle and is supported by a collapsible frame assembly. In one embodiment, the cover may be adapted to fit over the roof and windshield of the vehicle, and may be attached to the vehicle using various attachment means. The rear portion of the cover extends beyond the rear of the vehicle in order to provide an area under which people may stand or sit, in order to escape direct sunlight, rain, sleet or other elements of the outdoors. The collapsible frame assembly may include a pair of legs and an arch assembly to support the rear shelter portion of the cover, and may consist of a series of flexible pole members that fit together, similarly to tent poles.

In one embodiment, a user may open the trunk of the vehicle, and use the trunk lid to support one side of the shelter portion of the cover. The cover may include a pair of straps that run underneath the open lid of the trunk, and the straps are used to attach the cover to the open trunk lid. Other straps may be used to attach the cover to the vehicle. For example, one strap may be attached to a front portion of the cover, and it may be positioned underneath the vehicle from one side to the other adjacent the front wheels, in order to secure the cover to the vehicle. A second strap may be similarly positioned so that it runs underneath the vehicle adjacent the rear wheels. It is also contemplated that straps or other attachment means may be positioned on a front bumper.

In one embodiment, the cover is positioned so that it overlays the front windshield, the roof of the vehicle, the trunk area, and extends several feet past the rear of the vehicle to provide a shady or protected area adjacent the trunk. This arrangement does not cover the side windows or doors of the vehicle, so that the doors and windows may be used (opened or closed) while the cover is in place, so that users have access to the inside of the vehicle without having to remove the cover.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a vehicle cover and shelter that is operatively attached to a vehicle, in accordance with one aspect of the present invention; and

FIG. 2 is a perspective view of a vehicle cover and shelter that is operatively attached to a vehicle, in accordance with one aspect of the present invention.

### DETAILED DESCRIPTION OF THE INVENTION

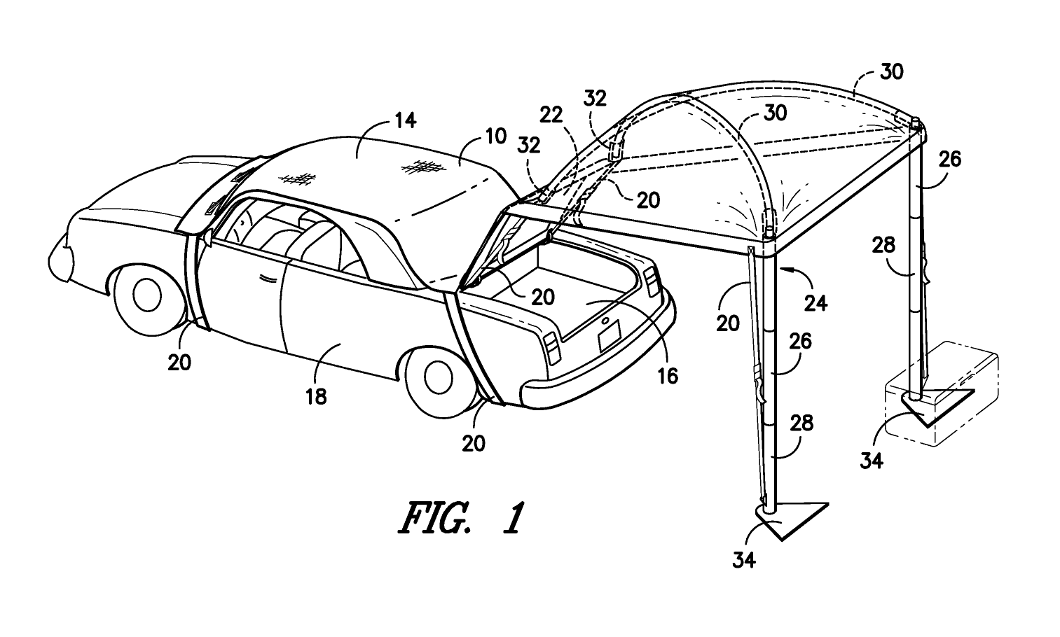

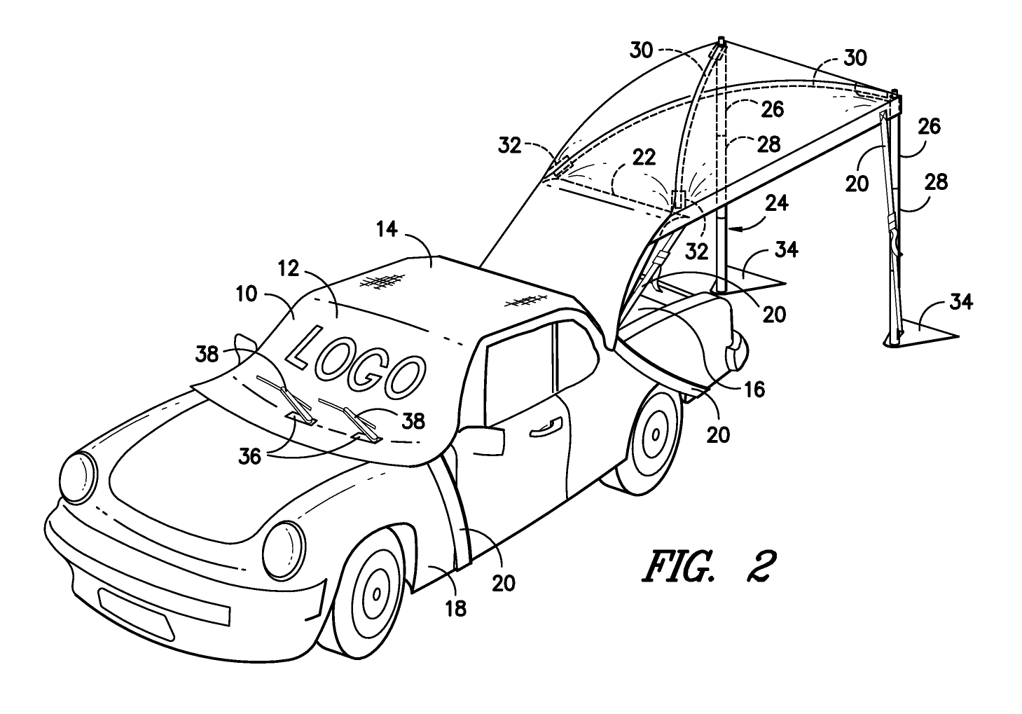

A first embodiment of a vehicle cover and shelter 10 is shown in FIGS. 1 and 2. The cover 10 is positioned to overlay the front windshield 12, the roof 14, the trunk 16, and extends beyond the rear of the vehicle 18 to provide a sheltered area thereunder. The cover 10 may be manufactured from any suitable material, but is preferably made from a material that is waterproof or water resistant, lightweight, and strong. In one embodiment, the cover 10 is attached to the vehicle 18 using a series of straps 20, although other types of attachment means may be used, including stretch cords, snaps, or the like. The cover 10 is preferably attached to an open trunk lid 22, as shown in FIG. 2, so that the trunk lid 22 serves as a support for the rear portion of the cover 10.

In a preferred embodiment, a collapsible frame assembly 24 may be assembled and connected to a rear portion of the cover 10, so that the cover 10 provides a sheltered area adjacent the trunk 16 or rear of the vehicle 18, as shown in FIGS. 1 and 2. The collapsible frame assembly 24 may include a series of flexible poles 26 that fit together to form the collapsible frame assembly 24, similarly to the manner in which tent poles are assembled to support a tent. The collapsible frame assembly 24 includes a pair of legs 28 and a pair of arch members 30. Each leg 28 is oriented vertically, and is attached to a rear corner of the cover 10. Each arch member 30 is attached to the upper end of a leg 28, extends diagonally underneath the shelter portion of the cover 10 and is attached to the cover 10 adjacent an opposed corner of the trunk lid 22, as shown. The arch members 30 cross each other to provide support to the shelter portion of the cover 10. The cover 10 may include a pair of pockets 32 to receive the ends of the arch members 30 adjacent the trunk lid 22, as shown, although it is contemplated that other means may be used to attach the arch members 30 to the cover 10. The legs 28 and the arch members 30 may comprise smaller pole sections 26 that fit together, similarly to tent poles, so that the entire collapsible frame assembly 24 may be disassembled and stored in a compact manner.

In one embodiment, each leg 28 may include an enlarged, flat foot 34, as shown. This arrangement allows a user to place a heavy object, such as a cooler, on top of the foot 34 in order to secure the foot 34 against the ground and prevent the leg 28 from sliding or moving with respect to the ground, as illustrated in FIG. 1. Other means may be used to secure the legs 28 to the ground, including stakes that may be driven through holes in the feet and into the ground, or any other suitable means, if necessary. Additionally, the cover 10 may be attached to the legs 28 using adjustable straps 20 that are capable of being cinched down or tightened, as shown, so that the upper portion of the strap 20 is attached to the cover 10, and the lower portion of the strap 20 is attached to a bottom portion of an adjacent leg 28.

Various means may be employed to attach the cover 10 to the vehicle 18. In one embodiment, a front strap 20 is attached to the cover 10 adjacent a bottom corner of the windshield 12 on either side of the vehicle 18. The front strap 20 includes two sections that may be connected using an adjustable buckle or other attachment means, so that one section of the disconnected strap 20 may be positioned underneath the vehicle 18 adjacent the front wheels, buckled to the second section, and tightened. Additionally, a second strap 20 may be similarly employed adjacent the rear wheels of the vehicle, as shown. It is also contemplated that straps 20 may be attached in other ways and places, such as the bumper.

Another set of straps 20 may be employed to connect the cover 10 to the open trunk lid 22. The trunk straps 20 are positioned so that the strap 20 may be fed through the opening between the trunk lid 22 and the vehicle 18 (adjacent the trunk lid hinge), along the underside of the trunk lid 22, and buckled to the second section of the strap 20 near the open, free end of the trunk lid 22, as shown in FIG. 1. This arrangement is advantageous because it allows the trunk lid 22 to remain open even during inclement weather while preventing rain water from entering the trunk 16. Preferably, the trunk straps 20 include buckles that allow the trunk straps 20 to be tightened and easily engaged or disengaged.

It is also contemplated that the front section of the cover 10 may include a pair of slits 36, so that when the cover 10 is placed on the vehicle 18, the windshield wipers 38 may be positioned through the slits 36 so that the windshield wipers 38 are used to hold the cover 10 against the windshield 12, as shown in FIG. 2. Optionally, the cover 10 may be used to display a team logo, advertisement, or other message, particularly in the area of the cover 10 over the windshield 12, as shown in FIG. 2.

This arrangement is advantageous in several ways. The vehicle cover and shelter may be employed to provide shade from the sun, both inside the vehicle as a windshield and rear windshield shade, and outside the vehicle. Tailgaters may set up chairs and/or a table beneath the rear shelter, and may use any heavy object on hand, such as a cooler, to stabilize the legs of the frame assembly. The vehicle cover and shelter may be quickly attached to and detached from a vehicle, and the frame assembly may be easily assembled and disassembled, and both the cover and frame assembly may be compactly stored when not in use.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What I claim is:

1. A vehicle cover and shelter comprising:
a cover adapted to overlay a windshield, a roof, and a trunk portion of a vehicle, wherein said cover extends rearwardly with respect to said vehicle beyond said trunk in order to provide a sheltered area thereunder, wherein said cover may be removably attached to said vehicle, and wherein said cover is situated so that doors of said vehicle may be opened and closed while said cover is attached to said vehicle;
a collapsible frame assembly attached to a rear portion of said cover in order to support said cover and provide said sheltered area thereunder; and
attachment means for attaching said cover to said vehicle;
wherein said cover may be positioned to overlay a windshield, roof, and trunk portion of a vehicle while simultaneously extending beyond said trunk in order to provide a sheltered area thereunder.

2. The vehicle cover and shelter set forth in claim 1, wherein said attachment means include at least two adjustable straps.

3. The vehicle cover and shelter set forth in claim 1, wherein said collapsible frame assembly includes a pair of legs and a pair of arch members.

4. The vehicle cover and shelter set forth in claim 3, wherein each leg comprises at least two pole members that fit together to form said leg, and which may be disassembled when not in use.

5. The vehicle cover and shelter set forth in claim 3, wherein each said arch member comprises at least two pole members that fit together to form said arch member, and which may be disassembled when not in use.

6. The vehicle cover and shelter set forth in claim 1, wherein said attachment means include a pair of trunk straps connected to said cover, wherein said trunk straps may be positioned on an underside of an open trunk lid and secured thereto.

7. The vehicle cover and shelter set forth in claim 1, wherein said cover includes a pair of slits, wherein each slit is adapted to receive a windshield wiper, so that said windshield wiper may be used to hold said cover against said windshield.

8. The vehicle cover and shelter set forth in claim 3, wherein each leg includes a flat foot member.

9. The vehicle cover and shelter set forth in claim 3, further comprising a pair of adjustable straps, wherein one end of each said strap is connected to said cover, and an opposed end of each strap is connected to a bottom portion of an adjacent leg.
